(19) United States
(12) Patent Application Publication
(10) Pub. No.: US 2026/0138594 A1
(43) Pub. Date: May 21, 2026

(54) AUTOMATED VALET PARKING SYSTEM AND AUTOMATED VALET PARKING METHOD

(71) Applicant: TOYOTA JIDOSHA KABUSHIKI KAISHA, Toyota-shi (JP)

(72) Inventors: Kazuhito Eshima, Toyota-shi (JP); Hidenobu Kinugasa, Nagoya-shi (JP); Takahiro Yamamoto, Toyota-shi (JP); Tatsuya Sugano, Seto-shi (JP)

(73) Assignee: TOYOTA JIDOSHA KABUSHIKI KAISHA, Toyota-shi (JP)

(21) Appl. No.: 19/360,231

(22) Filed: Oct. 16, 2025

(30) Foreign Application Priority Data
Nov. 19, 2024 (JP) 2024-201536

(51) Int. Cl. B60W 30/06; B60Q 1/14; G06V 10/141; G06V 20/52; H05B 47/175

(52) U.S. Cl. CPC B60W 30/06; B60Q 1/1415; G06V 10/141; G06V 20/52; H05B 47/175; B60Q 2900/30; B60W 2556/45

(57) ABSTRACT

Automated valet parking of a vehicle is performed within a predetermined area in which at least a surveillance camera and an illumination device are installed. The management device manages a surveillance camera, an illumination device, and automated valet parking. A control device of the vehicle is configured to perform vehicle control for the automated valet parking. The vehicle control includes remote driving control of a driving device of the vehicle performed based on a remote control command received from a management device, and remote lighting control of headlights of the vehicle performed based on a remote control command received from the management device during the remote driving control.

### CROSS-REFERENCE TO RELATED APPLICATION

This application claims priority to Japanese Patent Application No. 2024-201536 filed on Nov. 19, 2024. The disclosure of the above-identified application, including the specification, drawings, and claims, is incorporated by reference herein in its entirety.

### BACKGROUND

### 1. Technical Field

The present disclosure relates to automated valet parking (AVP) of a vehicle within a predetermined area, such as a parking lot.

### 2. Description of Related Art

Japanese Unexamined Patent Application Publication No. 2019-98911 (JP 2019-98911 A) discloses a device that supports the AVP of the vehicle. The support device is mounted in the vehicle. The vehicle performs autonomous driving control for the AVP in the parking lot. During autonomous driving control, the support device acquires an illuminance of an outside of the vehicle. In addition, the support device is configured to turn on headlights of the vehicle to support automated parking control when the illuminance of the outside of the vehicle is equal to or less than a predetermined threshold value.

### SUMMARY

A case where AVP is performed based on a remote command from an external device of a vehicle is considered. An external device in this case includes a management device that manages the AVP within a predetermined area, such as a parking lot. The management device also manages various devices installed in the predetermined area in association with the AVP. Various devices include a surveillance camera and an illumination device. With management of the illumination device by the management device, an illuminance in a dark place is secured, and an accuracy of object recognition using the surveillance camera is ensured.

However, in a case where lighting control of headlights of the vehicle is performed by independent determination of the vehicle during the AVP by the management device, the following problem is assumed. That is, during the AVP by the management device, the vehicle moves within the predetermined area. Therefore, in a case where the lighting control of the headlights is performed by the independent determination of the vehicle, an illuminance in the predetermined area fluctuates due to execution of the movement of the vehicle and the lighting control. In this case, depending on a degree of the fluctuation, there is a possibility that the accuracy of object recognition using the surveillance camera is reduced.

One object of the present disclosure is to provide a technology capable of suppressing a decrease in accuracy of object recognition by the surveillance camera in a case where the AVP by the management device is performed, in association with the lighting control of the headlights of the vehicle.

A first aspect of the present disclosure relates to an automated valet parking system.
The system is configured to perform automated valet parking of a vehicle within a predetermined area in which at least a surveillance camera and an illumination device are installed.
The system includes a management device and a control device.
The management device is configured to manage the surveillance camera, the illumination device, and the automated valet parking.
The control device is mounted in the vehicle. The control device is configured to perform vehicle control for the automated valet parking.
The vehicle control includes
remote driving control of a driving device of the vehicle performed based on a remote control command received from the management device, and
remote lighting control of headlights of the vehicle performed based on a remote control command received from the management device during the remote driving control.

A second aspect of the present disclosure relates to an automated valet parking method.
The method causes a computer to perform automated valet parking of a vehicle within a predetermined area in which at least a surveillance camera and an illumination device are installed.
The method includes performing vehicle control for the automated valet parking by a control device of the vehicle.
The vehicle control includes remote driving control of a driving device of the vehicle performed based on a remote control command received from a management device, and remote lighting control of headlights of the vehicle performed based on a remote control command received from the management device during the remote driving control.

According to the first aspect or the second aspect, the remote lighting control of the headlights of the vehicle is performed during the remote driving control of the driving device of the vehicle. The remote driving control and the remote lighting control are performed based on the remote control command received from the management device. Therefore, in a case where the remote lighting control is performed, it is possible to suppress the fluctuation of the illuminance that may occur in a case where the lighting control of the headlights is performed by the independent determination of the vehicle. Therefore, it is possible to suppress the decrease in the accuracy of the object recognition using the surveillance camera.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of an automated valet parking system;

FIG. 2 is a conceptual diagram illustrating features of an embodiment;

FIG. 3 is a diagram showing an example of setting a front area of a vehicle;

FIG. 4 is a flowchart particularly related to lighting control of headlights; and

FIG. 5 is a flowchart particularly related to the lighting control of the headlights.

### DETAILED DESCRIPTION OF EMBODIMENTS

Hereinafter, embodiments of the present disclosure will be described with reference to the drawings. In each drawing, the same or corresponding portions are represented by the same reference numerals and description thereof will be simplified or will not be repeated.

### 1. Entire Configuration Example of System

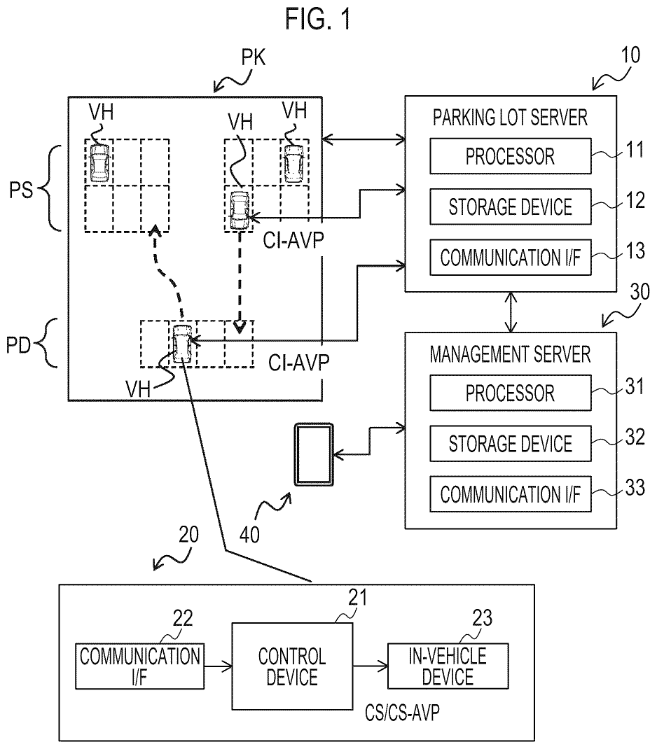

An automated valet parking system (AVP system) is a system that automatically performs a parking operation of a vehicle within a predetermined area such as a parking lot, a factory, or a facility. FIG. 1 is a diagram showing a configuration example of an AVP system. FIG. 1 shows a parking lot PK as a predetermined area. The parking lot PK has a configuration capable of executing the AVP. A configuration in which the AVP can be executed includes a pick-up and drop-off space PD and a parking space PS. The pick-up and drop-off space PD is a space for either getting off a vehicle VH, getting on the vehicle VH, or both. The parking space PS is a space for parking the vehicle VH. In addition, the AVP-executable configuration also includes a marker, an illumination device, and a sensor (for example, a camera, a radar, and an illuminance meter) that assists in the movement of the vehicle VH in the parking lot PK, and that surveils the inside of the parking lot PK.

FIG. 1 also shows a server 10 (hereinafter, also referred to as a “parking lot server”) that manages the AVP in the parking lot PK. The parking lot server 10 performs various types of processing related to the management of the operation authority of the vehicle VH needed for the AVP at the parking lot PK. The parking lot server 10 further acquires various pieces of information from the sensors of the parking lot PK, and performs various types of processing related to the execution of the AVP in the parking lot PK based on the various pieces of information. The parking lot server 10 may be a combination of a server (local server) that performs various types of processing related to the execution of the AVP and a server (cloud server) that performs various types of processing related to the management of the AVP.

The parking lot server 10 is typically a computer including at least one processor 11, at least one storage device 12, and a communication interface (I/F) 13. The processor 11 executes various types of processing. Examples of the processor 11 include a central processing unit (CPU), a graphics processing unit (GPU), an application specific integrated circuit (ASIC), and a field-programmable gate array (FPGA). The processor 11 can also be referred to as “circuitry” or “processing circuitry”. The “circuitry” is hardware programmed to implement functions described or hardware that executes the functions. The processor 11 reads out various pieces of information from the storage device 12 and stores various pieces of information in the storage device 12.

The storage device 12 includes a volatile memory, a non-volatile memory, a hard disk drive (HDD), a solid state drive (SSD), and the like. Examples of various pieces of information stored in the storage device 12 include a parking lot map, parking lot use information, parking lot environment information, and vehicle management information.

The parking lot map information indicates map information of the parking lot PK. The parking lot usage information is information regarding the use status (vacancy information) of the pick-up and drop-off space PD and the parking space PS in the parking lot PK. The vehicle management information includes information such as a vehicle ID, a vehicle storage and retrieval time, and a vehicle position. The parking lot environment information is information about the environment in the parking lot PK. The parking lot environment information includes environment information (for example, object recognition information based on a camera image from a camera, a distance measurement value from a radar, or the like) acquired from various sensors installed in the parking lot PK, and illuminance information based on a detection value of an illuminance meter. The vehicle management information is managed for each vehicle VH. The vehicle ID is identification information of the vehicle VH. The vehicle storage and retrieval time is information on the time of the in-out of the vehicle VH (for example, reservation time and actual time). The vehicle position indicates information on a position of the vehicle VH in the parking lot PK.

The communication I/F 13 is an interface for transmitting and receiving information by communicating with a device outside the parking lot server 10. For example, the communication I/F 13 is configured by a device for connecting to the surrounding device via the wireless LAN, a device for connecting to the mobile communication network, a device for connecting to the Internet, and the like. The parking lot server 10 transmits and receives information to and from the vehicle VH (vehicle system 20) via the communication I/F 13. The parking lot server 10 also transmits and receives information to and from a management server 30 via the communication I/F 13.

Further, in FIG. 1, the vehicle system 20 is shown. The vehicle system 20 is mounted in each of the vehicles VH as a system capable of executing the AVP. The vehicle system 20 includes a control device 21, a communication I/F 22, and an in-vehicle device 23.

The control device 21 is communicably connected to the communication I/F 22 and the in-vehicle device 23. The control device 21 is a computer that performs information processing related to the control of the vehicle VH based on various pieces of information. The control device 21 includes at least one processor and at least one storage device. A configuration example of the processor of the control device 21 is the same as that of the processor 11. In addition, a configuration example of the storage device of the control device 21 is the same as that of the storage device 12. The processor of the control device 21 cooperates with the storage device of the control device 21 to realize information processing related to the control of the vehicle VH.

For example, the control device 21 is configured by one or more electronic control units (ECUs). In another example, the control device 21 is configured by a kit (for example, an AVP kit) for the function provided by the parking lot server 10. The control device 21 generates and outputs a control signal of the vehicle VH by information processing. When the vehicle VH receives the control command (remote control command) CI-AVP for the AVP operation (for example, the entry operation, the exit operation) from the parking lot server 10, the control device 21 generates a control signal CS-AVP for the AVP operation. The control signal CS-AVP is transmitted to the in-vehicle device 23.

The communication I/F 22 is an interface for transmitting and receiving information by communicating with a device outside the vehicle VH. The vehicle VH transmits and receives information to and from the parking lot server 10 via the communication I/F 22. In addition, the vehicle VH can also transmit and receive information to and from a user terminal 40 via the communication I/F 22.

The in-vehicle device 23 includes a light device, an in-vehicle illumination device, a horn, a wiper, a door, a door window, a mirror, a drive device, a braking device, a steering device, a human machine interface (HMI), and the like. The illumination device includes headlights, a blinker, a tail lamp, a back lamp, and the like. Each device of the in-vehicle device 23 includes an actuator that can be controlled by the control device 21. The in-vehicle device 23 acquires a control signal CS from the control device 21. The control device 21 controls the in-vehicle device 23 by the actuator operating in response to the control signal CS. In addition, the control of the vehicle VH is realized by the control of the in-vehicle device 23. A drive device, a braking device, and a steering device in the in-vehicle device 23 are referred to as a driving device. The driving control of the vehicle VH is realized by the actuator of the driving device operating in response to the control signal CS.

The control signal CS includes the control signal CS-AVP. The vehicle control for the AVP operation is realized by the actuator operating in response to the control signal CS-AVP. In particular, the driving control (remote driving control) for the AVP operation is realized by the operation of the actuator of the driving device described above in response to the control signal CS-AVP.

Further, FIG. 1 also shows the management server 30. The management server 30 is a server (cloud server) that manages the entire AVP service. The management server 30 manages a user who uses the AVP service (hereinafter, also referred to as an “AVP user”) and a vehicle having the vehicle system 20 (that is, the vehicle VH). The management of the AVP user includes the authentication of the AVP user and the management of the reservation of the AVP by the AVP user. The management of the vehicle VH includes the management of the vehicle information of the vehicle VH, the management of the operation permission of the vehicle VH, and the management of the AVP operation log of the vehicle VH.

The management server 30 performs various types of processing related to the management of the reservation of the AVP in the parking lot PK. The management server 30 is typically a computer including at least one processor 31, at least one storage device 32, and a communication I/F 33. A configuration example of the processor 31 is the same as that of the processor 11. In addition, a configuration example of the storage device 32 is the same as that of the storage device 12.

Examples of various pieces of information stored in the storage device 32 include the AVP reservation information, the user information, and the AVP vehicle information.

The AVP reservation information is information regarding a reservation of the AVP by the AVP user. The AVP reservation information includes information such as a parking lot that the AVP user wants to use and a vehicle storage and retrieval time. The user information includes information such as a user ID of the AVP user and a vehicle ID of the vehicle used by the AVP user. The user information is managed for each AVP user. The AVP vehicle information includes information such as a vehicle ID of the vehicle having the vehicle system 20, an IP address of the vehicle system 20, and an AVP operation log by the vehicle system 20. The AVP vehicle information also includes equipment information of the vehicle having the vehicle system 20. The equipment information is information related to the in-vehicle equipment. Examples of the in-vehicle equipment related to the present disclosure include headlights system.

The communication I/F 33 is an interface for transmitting and receiving information by communicating with a device outside the management server 30. For example, the communication I/F 33 is configured by a device for connecting to the surrounding device via the wireless LAN, a device for connecting to the mobile communication network, a device for connecting to the Internet, and the like. The management server 30 transmits and receives information to and from the parking lot server 10 via the communication I/F 33. The management server 30 also transmits and receives information to and from the user terminal 40 via the communication I/F 33.

The user terminal 40 is a terminal carried by the AVP user (for example, a smartphone). The AVP user transmits and receives information to and from the vehicle VH (vehicle system 20) by operating the user terminal 40. The AVP user also transmits and receives information to and from the management server 30 by operating the user terminal 40. The user terminal 40 is used for the use registration or the use reservation of the AVP service by the AVP user. The user terminal 40 is also appropriately used for the AVP at the parking lot PK. Instead of the operation of the user terminal 40, the information on the AVP may be transmitted and received by the operation of the terminal (for example, HMI) mounted in the vehicle VH.

### 2. AVP Processing

When the AVP processing (vehicle storage processing) is executed, for example, the parking lot server 10 transmits and receives information to and from the management server 30 to acquire the operation permission of the vehicle VH waiting in the pick-up and drop-off space PD. By transferring the operation permission to the parking lot server 10, the AVP of the vehicle VH by the parking lot server 10 (processor 11) becomes executable. The vehicle system 20 generates the control signal CS-AVP in accordance with the control command CI-AVP of the AVP operation (vehicle entry operation) received from the parking lot server 10, and controls the in-vehicle device 23. As a result, the vehicle control for the AVP operation (entrance operation) from the pick-up and drop-off space PD to the parking space PS is performed.

When the AVP processing (pick-up process) is performed, for example, the vehicle system 20 generates the control signal CS-AVP in response to the control command CI-AVP of the AVP operation (pick-up operation) received from the parking lot server 10, and controls the in-vehicle device 23. As a result, the vehicle control for the AVP operation (pick-up operation) from the parking space PS to the pick-up and drop-off space PD is performed. When the vehicle VH arrives at the pick-up and drop-off space PD, the parking lot server 10 transmits and receives information to and from the management server 30 to return the operation permission of the vehicle VH. By transferring the operation permission to the management server 30, the execution of the AVP of the vehicle VH by the parking lot server 10 (processor 11) ends.

### 3. Features of Embodiment

### 3-1. Lighting Control of Headlight

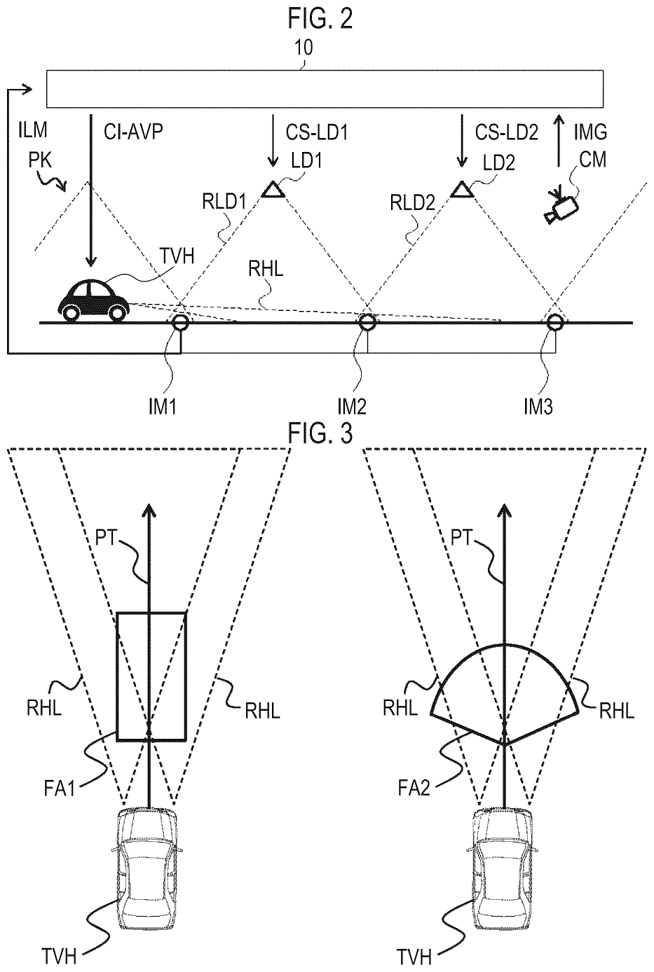

FIG. 2 is a conceptual diagram illustrating the features of the AVP processing according to the embodiment. FIG. 2 shows a vehicle VH (hereinafter, also referred to as a “target vehicle TVH”) that is a target of the AVP processing. The target vehicle TVH performs the AVP operation based on the control command CI-AVP received from the parking lot server 10. The AVP operation includes traveling of the target vehicle TVH. The traveling of the target vehicle TVH is realized by driving control performed by the vehicle system 20 (control device 21) mounted in the target vehicle TVH.

During the driving control by the vehicle system 20, the headlight lighting operation of the target vehicle TVH is controlled by the vehicle system 20. The control of the lighting operation (lighting control) is, for example, “normal headlight lighting control” based on internal information (for example, vehicle speed, steering angle) or external information (for example, surrounding illuminance) of the target vehicle TVH detected by an in-vehicle sensor of the target vehicle TVH. Examples of the normal lighting control include a lighting operation (for example, high beam irradiation, swivel irradiation, and luminous intensity adjustment) performed in accordance with a preset lighting mode in addition to the lighting of the headlights.

Incidentally, the parking lot PK is provided with an illumination device LD (LD1 and LD2 in the example shown in FIG. 2) for the purpose of securing the accuracy of the object recognition by the camera CM. Therefore, the irradiation range RLD (RLD1 and RLD2) of the illumination device LD may overlap with the irradiation range RHL of the headlights of the target vehicle TVH. When the irradiation range RLD overlaps the irradiation range RHL, the illuminance around the target vehicle TVH is expected to increase, and the accuracy of recognition of the target vehicle TVH and the object around the target vehicle TVH using the camera image IMG is expected to be improved.

However, for example, in a case where the headlights are turned off, the headlights are turned on by the normal lighting control. In this case, since the irradiation range RLD overlaps the irradiation range RHL, there is a possibility that the illuminance around the target vehicle TVH is varied. In another example, the headlights are turned on by the normal lighting control, and the turn-on mode is switched. In this case, the range in which the irradiation range RLD and the irradiation range RHL overlap may vary, and the illuminance around the target vehicle TVH may vary.

When the illuminance around the target vehicle TVH is changed, depending on the degree of the change in the illuminance, there is a possibility that the accuracy of the object recognition using the camera image IMG is reduced. Therefore, in the AVP processing according to the embodiment, the intervention of the parking lot server 10 in the headlight lighting control is allowed. The following will be described for convenience, the headlight lighting control performed by the intervention of the parking lot server 10 is referred to as “remote lighting control”, and the normal lighting control is referred to as “local lighting control”.

### 3-2. Remote Lighting Control

The remote lighting control is performed based on a control command (remote control command) CI-HL for the lighting operation of the headlights. The control command CI-HL is included in the control command CI-AVP transmitted from the parking lot server 10. When the control command CI-HL is received, the vehicle system 20 (control device 21) of the target vehicle TVH generates the control signal CS-HL for the headlight-on operation. The control signal CS-HL is transmitted to the headlights of the target vehicle TVH.

### 3-2-1. First Example of Remote Lighting Control

The control command CI-HL includes, for example, a command (execution prohibition command) for prohibiting the execution of the local lighting control. When the execution prohibition command is received, the headlights of the target vehicle TVH are prohibited from being turned on or the turn-on operation is prohibited from being performed based on the internal information (for example, vehicle speed, steering angle) or the external information (for example, surrounding illuminance) of the target vehicle TVH.

The execution prohibition command is generated based on, for example, the illuminance IL-FA of the front area FA of the target vehicle TVH. The front area FA is set based on the position of the target vehicle TVH included in the vehicle management information stored in the storage device 12. FIG. 3 is a diagram showing a setting example of the front area FA. FIG. 3 shows a traveling path PT of the target vehicle TVH. Here, the traveling path PT is a set of path points through which the target vehicle TVH is to pass from the current position of the target vehicle TVH to the destination. The traveling path PT is sequentially generated based on, for example, the parking lot environment information stored in the storage device 12. The front area FA1 includes at least a part of the traveling path PT.

FIG. 3 also shows the irradiation ranges RHL, RHL of the right and left headlights of the target vehicle TVH. In the example shown in FIG. 3, the front area FA1 is a certain rectangular area (for example, vertical width: 5 m to 15 m, horizontal width: 1 m to 3 m) extending in front of the target vehicle TVH from the area in which the irradiation ranges RHL, RHL overlap each other. Note that the shape of the front area FA is not limited to thereto, and may be a fan-shaped region such as the front area FA2. The front area FA2 is set to include at least the traveling path PT, similar to the front area FA1.

The illuminance IL-FA is calculated by using an illuminance meter around the front area FA of the target vehicle TVH. In the example shown in FIG. 2, the illuminance meters IM1, IM2, IM3 are installed on a floor surface in front of the target vehicle TVH. Each detection value ILM of the illuminance meters is transmitted to the parking lot server 10. The parking lot server 10 calculates the illuminance distribution in the front area FA by using, for example, the position of the front area FA, the positions of the illuminance meters IM1, IM2, IM3, and each detection value ILM. The parking lot server 10 also calculates a value (evaluation value) ILev-FA for evaluating the illuminance of the front area FA from the illuminance distribution and compares the value with a predetermined illuminance ILth. Then, in a case where the evaluation value ILev-FA exceeds the predetermined illuminance ILth, the parking lot server 10 generates the control command CI-HL including the execution prohibition command and transmits the control command CI-HL to the target vehicle TVH. Examples of the evaluation value ILev-FA include the maximum illuminance, the minimum illuminance, and the average illuminance in the illuminance distribution.

The execution prohibition command may be a command to prohibit the execution of a part of the local lighting control. For example, the execution prohibition command may prohibit a lighting operation (for example, high beam irradiation, swivel irradiation, and light intensity adjustment) performed in accordance with the lighting mode. In this case, the headlights of the target vehicle TVH are allowed to be turned on by the local lighting control.

### 3-2-2. Second Example of Remote Lighting Control

The execution prohibition command may be generated based on the recognition likelihood LH-FA of the object using the camera image IMG (IMG-FA) including the front area FA. In a case where the object recognition using the camera image is performed, the object is detected from the camera image, and the recognition information for the detected object is added. In this case, the recognition information includes information indicating the certainty of the detection of the detected object (that is, the recognition likelihood). The second example is performed using the likelihood information.

The camera image IMG-FA includes an image of an object in the front area FA or an object around the front area FA. The camera image IMG-FA may include an image of the target vehicle TVH. The parking lot server 10 acquires the recognition likelihood LH-FA included in the recognition information of the object detected in the camera image IMG-FA and compares the recognition likelihood LH-FA with a predetermined likelihood LHth. Then, in a case where the recognition likelihood LH-FA is lower than the predetermined likelihood LHth, the parking lot server 10 generates the control command CI-HL including the execution prohibition command and transmits the control command CI-HL to the target vehicle TVH. The recognition likelihood LH-FA may be the recognition likelihood of a single object detected in the camera image IMG-FA or an average value of the recognition likelihoods of a plurality of objects.

### 3-2-3. Third Example of Remote Lighting Control

The control command CI-HL may include information that urges the target vehicle TVH to perform an active lighting operation of the headlights. Examples of the positive lighting operation include the light intensity adjustment of the headlights. When the luminous intensity of the headlights of the target vehicle TVH is adjustable, the parking lot server 10 calculates the target luminous intensity of the headlights such that the illuminance IL-FA is equal to or less than a predetermined illuminance ILth. The target luminous intensity can be calculated, for example, by applying a difference between the illuminance IL-FA and a predetermined illuminance ILth to a relationship equation between the luminance and the illuminance (luminance (candela)=illuminance (lux)×square of a distance from a position of the headlights to a reference position of the front area FA). The reference position is a center of the front area FA, a position farthest from the target vehicle TVH, or a nearest position. The third example can be combined with the first or second example described above.

In a case where the control command CI-HL including the target luminous intensity is received from the parking lot server 10, the control device 21 of the target vehicle TVH adjusts the luminance of the headlights based on the target luminous intensity and the current luminance.

### 4. Computer Processing Example

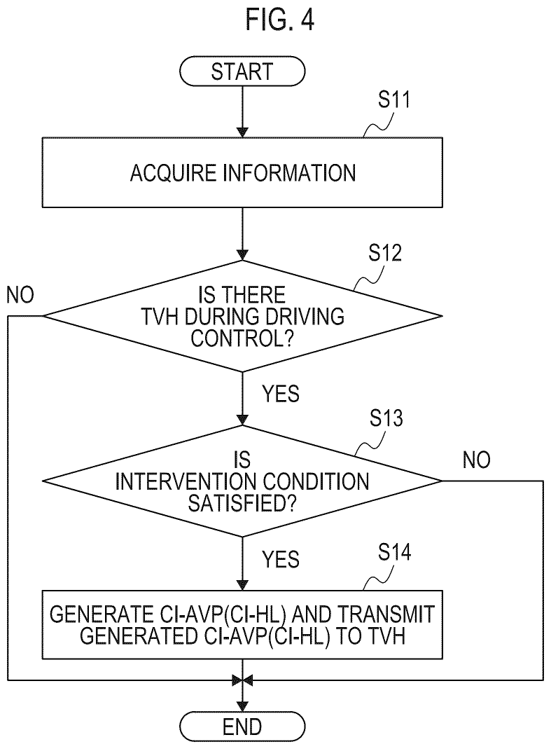

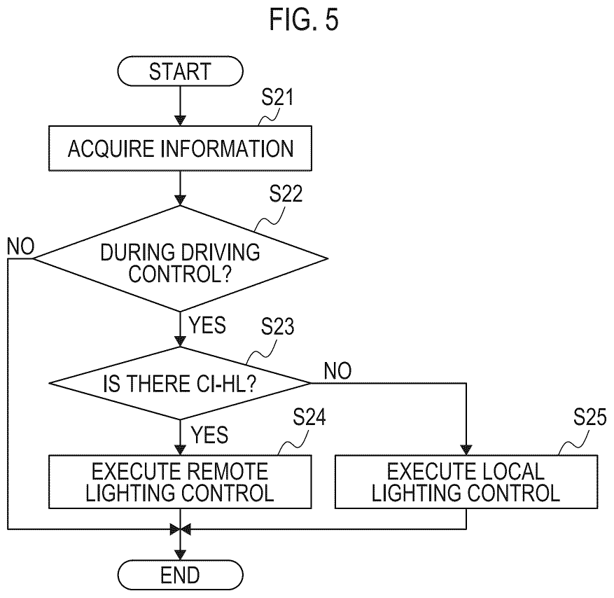

FIGS. 4 and 5 are flowcharts particularly related to the headlight lighting control. The processing routine shown in FIG. 4 is repeatedly executed by the parking lot server 10 (processor 11) at a predetermined cycle, for example. The processing routine shown in FIG. 5 is repeatedly executed at a predetermined cycle by, for example, the control device 21 (processor) of the target vehicle TVH.

In the routine shown in FIG. 4, first, in the process of S11, various pieces of information are acquired. Examples of the various pieces of information include the parking lot map information, the parking lot use information, the parking lot environment information, and the vehicle management information stored in the storage device 12. Various pieces of information include information received from the management server 30.

Subsequently to the process of S11, the process of S12 is performed. In the process of S12, determination is made whether the vehicle VH (that is, the target vehicle TVH) during the driving control for the AVP operation is present. The determination in S12 is made based on, for example, the vehicle management information (vehicle position information) acquired in the process of S11, the parking lot environment information (recognition information of the vehicle VH using the camera image), and the like. When the determination result of S12 is negative, the process ends.

When the determination result in S12 is affirmative, the process of S13 is performed. In the process of S13, determination is made whether the intervention condition is satisfied. The intervention condition is set, for example, as follows corresponding to the first to third examples of the remote lighting control described above.
(1) The evaluation value ILev-FA exceeds the predetermined illuminance ILth (First Example)
(2) The recognition likelihood LH-FA is less than a predetermined likelihood LHth (second example)
(3) The headlights of the target vehicle TVH are adjustable in light intensity and a target luminous intensity of the headlights is zero or more.
   When the determination result of S13 is negative, the process ends.

When the determination result in S13 is affirmative, the process of S14 is performed. In the process of S14, the control command CI-AVP including the control command CI-HL according to the intervention condition satisfied in S13 is generated and transmitted to the target vehicle TVH. The control command CI-HL according to the intervention condition satisfied in S13 is, for example, as follows.
(1) Execution Prohibition Command of Local Lighting Control (First Example)
(2) Execution Prohibition Command of Local Lighting Control (Second Example)
(3) Execution command of remote lighting control including target luminous intensity of headlights (Third example)

In the routine shown in FIG. 5, first, in the process of S21, various pieces of information are acquired. Examples of the various pieces of information include the control command CI-AVP received by the target vehicle TVH from the parking lot server 10. The control command CI-AVP includes the information of the traveling path PT described in FIG. 3. Various pieces of information include internal and external information of the target vehicle TVH detected by the in-vehicle sensor of the target vehicle TVH.

After the process of S21, the process of S22 is performed. In the process of S22, determination is made whether the target vehicle TVH is in driving control for the AVP operation. The determination of S22 is made based on, for example, output information of the control signal CS-AVP generated based on the control command CI-AVP. The determination of S22 may be made based on the vehicle speed information of the target vehicle TVH.

When the determination result in S22 is affirmative, the process of S23 is performed. In the process of S23, determination is made whether the control command CI-HL is included in the information acquired in S21. As described above, the control command CI-HL is included in the control command CI-AVP transmitted from the parking lot server 10.

When the determination result in S23 is affirmative, the process of S24 is performed. In the process of S24, the remote lighting control is executed. The content of the remote lighting control is in accordance with the control command CI-HL acquired in S21. The example of the control command CI-HL is as described in the description of S14 of FIG. 4.

When the determination result in S23 is negative, the process of S25 is performed. In the process of S25, the local lighting control is executed. In the local lighting control, the lighting operation of the headlights of the target vehicle TVH is controlled based on the internal and external information of the target vehicle TVH acquired in S21.

What is claimed is:

1. A system that performs automated valet parking of a vehicle within a predetermined area in which at least a surveillance camera and an illumination device are installed, the system comprising:
a management device configured to manage the surveillance camera, the illumination device, and the automated valet parking; and
a control device configured to perform vehicle control for the automated valet parking, the control device being mounted in the vehicle,
wherein the vehicle control includes
remote driving control of a driving device of the vehicle performed based on a remote control command received from the management device, and
remote lighting control of headlights of the vehicle performed based on a remote control command received from the management device during the remote driving control.

2. The system according to claim 1, wherein:
the lighting control further includes local lighting control of the headlights performed based on detection information of a sensor mounted in the vehicle;
the remote control command includes an execution prohibition command of the local lighting control; and
the management device is configured to
calculate an illuminance of a front area of the vehicle during the remote driving control, and
transmit the execution prohibition command to the control device when the illuminance of the front area exceeds a predetermined illuminance.

3. The system according to claim 1, wherein:
the lighting control further includes local lighting control of the headlights based on detection information of a sensor mounted in the vehicle;
the remote control command includes an execution prohibition command of the local lighting control; and
the management device is configured to transmit the execution prohibition command to the control device when a recognition likelihood of an object using a camera image from the surveillance camera is less than a predetermined likelihood, the camera image including a front area of the vehicle acquired during the remote driving control.

4. The system according to claim 1, wherein the management device is configured to
calculate an illuminance of a front area of the vehicle during the remote driving control,
calculate a target luminous intensity of the headlights at which the illuminance of the front area is equal to or less than a predetermined illuminance, and
transmit the remote control command including the target luminous intensity to the control device.

5. A method that causes a computer to perform automated valet parking of a vehicle within a predetermined area in which at least a surveillance camera and an illumination device are installed, the method comprising performing vehicle control for the automated valet parking by a control device of the vehicle,
wherein the vehicle control includes
remote driving control of a driving device of the vehicle performed based on a remote control command received from a management device that manages the surveillance camera, the illumination device, and the automated valet parking, and
remote lighting control of headlights of the vehicle performed based on a remote control command received from the management device during the remote driving control.
